(19) United States
(12) Patent Application Publication
(10) Pub. No.: US 2013/0073405 A1
(43) Pub. Date: Mar. 21, 2013

(54) CUSTOMER EXPERIENCE MANAGEMENT SYSTEM

(71) Applicant: Charles A. Ariyibi, Stamford, CT (US)

(72) Inventor: Charles A. Ariyibi, Stamford, CT (US)

(21) Appl. No.: 13/621,181

(22) Filed: Sep. 15, 2012

Related U.S. Application Data
(63) Continuation-in-part of application No. 12/177,461, filed on Jul. 22, 2008, now Pat. No. 8,271,322.

(51) Int. Cl. G06Q 30/02; G06Q 20/20

(52) U.S. Cl. 705/17; 705/26.7

(57) ABSTRACT

A system and method for engaging a customer in an enhanced shopping experience. The customer provides customer information which is stored on a database. An identifying token (e.g. a card) is issued to the customer. This identifying token is detected (e.g. by an RFID sensor) when carried by the customer into a retailer's space. This causes at least a portion of the customer information to be accessible from the database by an automated shopping cart, which has capability to display customized information regarding items for sale located proximate to the cart.

### CROSS-REFERENCE TO RELATED APPLICATIONS

This application is a continuation-in-part of U.S. application Ser. No. 12/177,461, filed Jul. 22, 2008, the entire disclosure of which is incorporated herein by reference.

### FIELD OF THE DISCLOSURE

This disclosure relates to a system for facilitating a customer loyalty program, and more particularly to a system for offering an enhanced shopping experience in a retail store based on a customer's loyalty and preferences.

### BACKGROUND OF THE DISCLOSURE

Customer Relationship Management (CRM) systems use various information technologies to learn a customer's preferences, offer merchandise to the customer according to those preferences, and to foster or reward customer loyalty. In order to maintain a high level of customer loyalty, it is desirable for a retailer to identify its most loyal customers upon entry into its store premises and to provide those customers with an enhanced shopping experience by anticipating individual preferences and offering customized discounts and other services individually suited to each customer.

### SUMMARY OF THE DISCLOSURE

The present disclosure provides a method for engaging a customer in an enhanced shopping experience. The customer provides customer information which is stored on a database. An identifying token (e.g. a card) is issued to the customer. This identifying token is detected (e.g. by an RFID sensor) when carried by the customer into a retailer's space. This causes at least a portion of the customer information to be accessible from the database to retail personnel while the customer is physically present in the retailer's space, thereby facilitating personal engagement by the retail personnel with the customer.

The identifying token may include a first RFID transmitter used in detecting presence of the customer and in tracking the customer's movements, and a second RFID transmitter used in facilitating a purchase.

The method may also include determining whether the customer has elected to share customer information with the retailer. If the customer has not elected to share customer information with the retailer, a message is transmitted to the customer upon the customer's entry into the store, offering the enhanced shopping experience. Customer information from the database is then made accessible to retail personnel in accordance with an authorization message from the customer, and the customer information is accessible to the retail personnel only while the customer is physically present in the store.

According to another aspect of the invention, a system comprises a server configured to include a customer portal, a store portal, a database, an identifying token (including, e.g. an RFID transmitter) carried by the customer, and a sensor installed in the store. The customer portal, accessible by a customer over a network, permits entry of customer information. The store portal, accessible by retail personnel over the network, is used to transmit a message to the retail personnel regarding physical presence of the customer in the store, and permits retrieval of at least a portion of the customer information by the retail personnel. The database is in communication with the server and stores the customer information. The sensor receives a signal from the identifying token, indicating that a customer carrying the identifying token has entered the retailer's space. While in the store the customers browsing habits and shopping activities are detected and used in providing instant price discounts and other loyalty rewards and privileges based upon the individual customer's loyalty rating and eligibility status as determined by the retailer in order to provide a customized shopping experience.

The foregoing has outlined, rather broadly, the preferred features of the present disclosure so that those skilled in the art may better understand the detailed description of the disclosure that follows. Additional features of the disclosure will be described hereinafter that form the subject of the claims of the disclosure. Those skilled in the art should appreciate that they can readily use the disclosed conception and specific embodiment as a basis for designing or modifying other structures for carrying out the same purposes of the present disclosure and that such other structures do not depart from the spirit and scope of the disclosure in its broadest form.

### BRIEF DESCRIPTION OF THE DRAWINGS

FIGS. 1A and 1B are connected flowcharts illustrating steps in a CEM process, according to an embodiment of the disclosure.

FIG. 2 schematically illustrates a system for registering a customer with a CEM service using a customer portal, according to an embodiment of the disclosure.

FIG. 3 schematically illustrates a system for offering an enhanced shopping experience to a registered customer using an RFID personal identifier and a store portal, according to an embodiment of the disclosure.

FIG. 4 schematically illustrates a system for offering an enhanced shopping experience to an unregistered customer, according to another embodiment of the disclosure.

FIG. 5 schematically illustrates a store configuration for tracking a customer's movements inside a store, according to another embodiment of the disclosure.

FIGS. 6A and 6B are connected flowcharts illustrating steps in a CEM process for an automated grocery store customer experience, in accordance with another embodiment of the disclosure.

FIG. 7 schematically illustrates an automated shopping cart used in the grocery CEM system of FIGS. 6A and 6B.

FIG. 8 schematically illustrates a grocery store customer entering information into his/her CEM system user profile, in accordance with a further embodiment of the disclosure.

FIG. 9 schematically illustrates a store configuration for tracking the movements of customers using the Automated Grocery Shopping cart inside a store, according to another embodiment of the disclosure.

FIG. 10 is a flowchart illustrating steps in a Medical Records Management System in accordance with another embodiment of the disclosure.

FIG. 11 illustrates a flowchart demonstrating process involved in an automated Absentee Electoral Balloting system in accordance with another embodiment of the disclosure.

### DETAILED DESCRIPTION

In a Customer Experience Management (CEM) system embodying the disclosure, a customer is issued a loyalty card or similar token having an RFID transmitter embedded therein. When the customer, carrying the card, enters a store, her presence is automatically signaled to store personnel. Store personnel are then able to retrieve individual customer information such as the customer's name, size, favorite colors, personal style preferences, etc. This permits the store to anticipate the customer's needs and offer personalized service, thereby enhancing the customer's in-store experience.

### CEM Process: Customer Registration and Identification

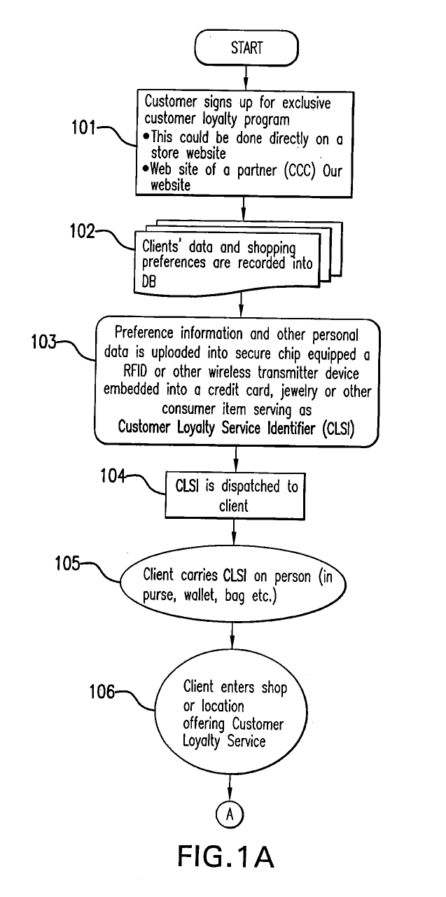

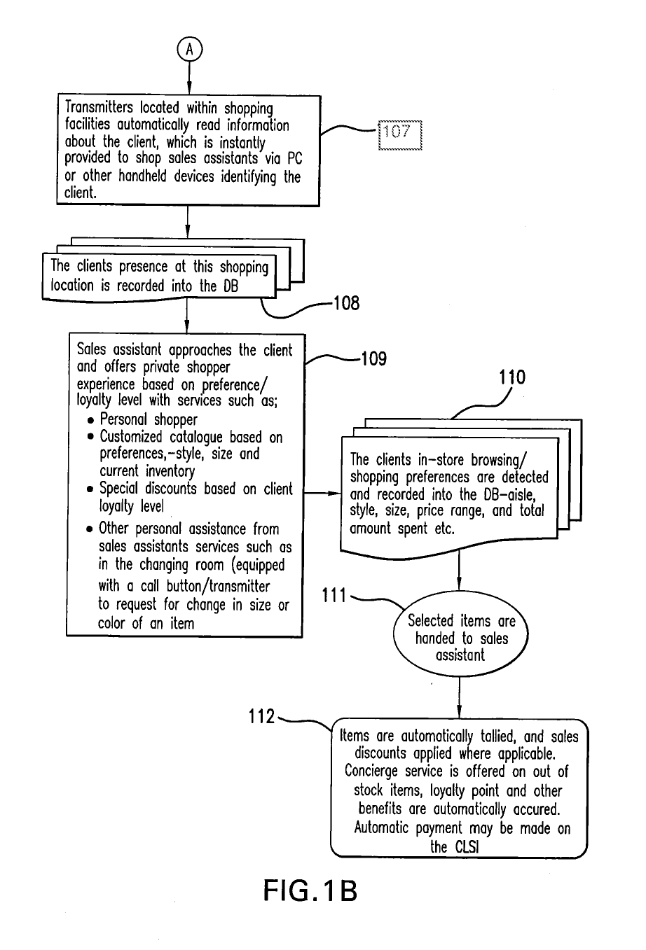

A flowchart of the CEM process, according to an embodiment, is shown in FIGS. 1A and 1B. The customer initiates the process by registering in a retailer's customer loyalty program (step 101). This is advantageously done using an on-line connection to a customer portal, described in further detail below. The customer may register directly with the retailer through the retailer's own website, or by visiting a partnering website (e.g. a website operated by a CEM vendor on behalf of the retailer). As part of the registration process, the customer enters certain personal data and shopping preferences (step 102) which are stored on the CEM database.

In step 103, the information provided by the customer is encoded onto a secure, machine-readable medium (e.g. a memory chip) embedded into a card (e.g. a credit card) or other token (e.g. an item of jewelry) to be carried by the customer. A vicinity/proximity RFID transmitter, or other wireless transmitter device, is likewise embedded in the card or token. This item will be referred to herein as a Customer Loyalty Service Identifier (CLSI). The CLSI is prepared and sent to the customer (step 104).

In an embodiment, the transmitter is capable of signaling the presence of the customer carrying the CLSI at a range of about 1.5 m. The customer carries the CLSI on her person (step 105), so that when she enters a store participating in the CEM (step 106), her presence is automatically detected by sensors installed in the store.

### CEM Process: In-Store Experience

The in-store sensors, in-store PC terminals, and/or clerks' handheld devices are advantageously linked over a network to a store portal, described in further detail below. Once the customer's presence is detected, information about the customer is transmitted from the CLSI and/or retrieved from the CEM database, sent to the store portal (step 107), and then to store personnel. A store clerk thus may be alerted to a customer's entering the store by receiving a message on a handheld device; the clerk may then go to the customer and greet her by name. The customer's visit is tracked and recorded in the CEM database (step 108).

The store clerk proceeds to offer the customer a personalized shopping experience, in accordance with the customer's preferences (step 109). The store clerk is able to respond to the customers' individual needs based on the individual customer profile retrieved from the database; this provides the clerk with opportunities for up-selling and targeted sales. As the customer moves through the store, other in-store sensors keep a record of which displays or items held her interest; this information is used to update the customer's profile on the CEM database (step 110). If the customer has a CLSI but has not previously elected to share information with the retailer, store personnel (through the CEM system) may request authorization from the customer to access her online profile; this situation is discussed further below.

When the customer is ready to complete her purchases and leave the store (step 111), other services (e.g. loyalty discounts) may be offered in accordance with the information on the CLSI or the customer profile in the database. If the CLSI is included in a credit card, payment may be made automatically using the CLSI to charge the credit account (step 112). In another embodiment, information encoded on the CLSI may be used to link to the customer's bank account, so that payment for the purchase is automatically deducted from the bank account. In another embodiment, where several participating stores are grouped together (e.g. in a shopping mall), the customer could accumulate purchases in several stores perhaps in a shopping cart, and automatically pay for all purchases at once upon exiting the store or mall location.

### Customer Portal

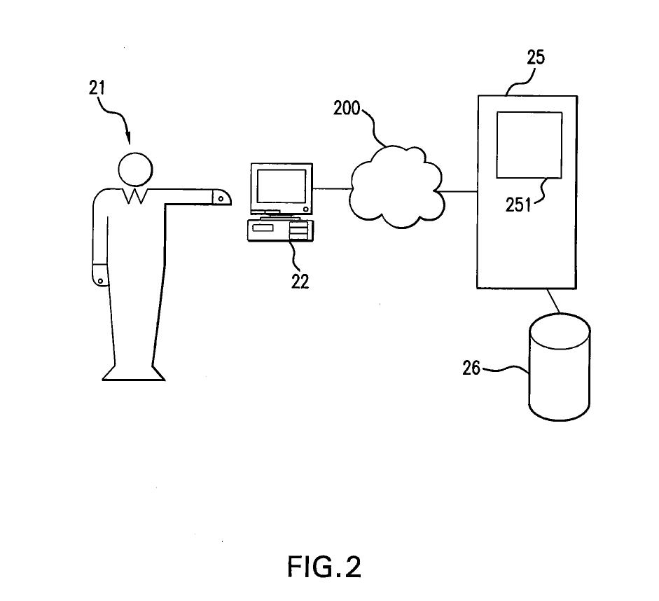

The customer portal provides a convenient means by which a customer may register for loyalty services. A CEM system including a customer portal is shown schematically in FIG. 2. In this embodiment, customer 21, using a PC 22, connects to a web server 25 over network 200 (e.g. the Internet). Customer portal 251 (software running on server 25) provides an access point for customer 21 to input personal information. The customer may also use any of a variety of devices to communicate with the portal over the network. The customer is invited to log in and respond to a series of questionnaires indicating personal information, shopping preferences and style information. In an embodiment, the customer also indicates customer loyalty programs to which she already belongs, selects from a list of participating retail stores and brands where the customer wishes to shop, and indicates online retailers where the customer maintains a personal profile. This information is then retained in a secure online database 26. A unique personal ID is assigned to the customer, and is embedded into the RFID based personal identifier or CLSI.

Customer 21 may be a member of more than one loyalty program. In an embodiment, customer portal 251 is configured to leverage, integrate and authenticate across other existing loyalty programs to which the customers may belong, and provide customer recognition and rewards based on individual status.

Customer 21 preferably accesses web server 25 using a secure technology such as SSL. The CLSI (RFID based personal identifier card, device or other form factor) is equivalent to a web browser cookie and single sign-on customer profile; the CLSI stores individual shopping preferences, facilitating instant customer recognition and multiplatform loyalty rewards and personalized shopping experience and benefits.

After registering, the customer may receive customized alerts and links pointing to sales and events relevant to her shopping preferences. In an embodiment, the customer may also input shopping lists which will be transmitted to participating stores that may be able to fulfill the requests.

### Customer Loyalty Card

In an embodiment, the CLSI (CEM personal identification) is based on a dual protocol (ISO 15693/ISO 14443) RFID transmitter embedded in a card or device of other form factor. The ISO 15693 and ISO 14443 protocols relate to “vicinity” and “proximity” devices respectively. The RFID transmitter thus functions both as a vicinity device permitting secure detection and authentication at distances of about 1.5 m (5 feet), and a proximity device serving as a highly secure low range transmitter. The proximity device is based on the same banking industry standards used with contactless payment cards offered by major credit card companies. In this embodiment, the CLSI may be used as a contactless credit or debit card. A customer has the option of automatically charging merchandise purchased via the CLSI to a designated credit card or bank account in the user profile.

### Store Portal

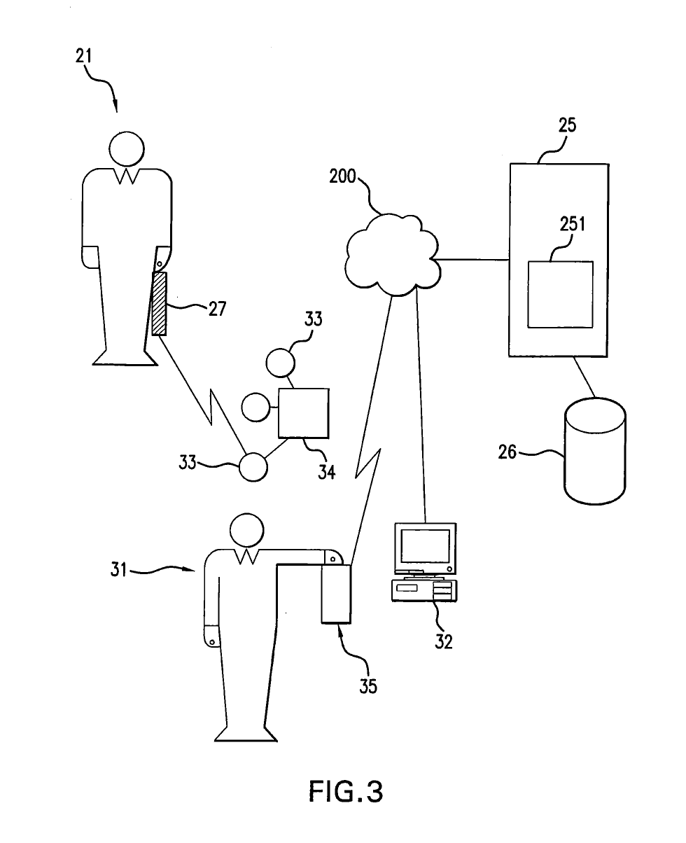

A CEM system including a store portal, schematically illustrating interaction between a customer 21 carrying a CLSI 27, the store portal 252, and store personnel 31, is shown in FIG. 3. Store portal 252 is shown running on server 25, and is linked to in-store devices (e.g. a store clerk's PC 32, a store clerk's handheld device 35, and RFID sensor controller 34 linked to sensors 33) via network 200. An RFID sensor 33 detects the customer's presence upon entering the store; a detection signal is automatically sent to the portal 252. The portal automatically generates an e-mail, SMS or MMS message for delivery to store clerk 31 via PC 32 and/or a “smart phone,” PDA or other handheld PC device 35. Store personnel may then authenticate to secure online database 26 and retrieve customer information therefrom. This information may include relevant portions of the customer's profile (e.g. shopping preferences related to the particular store, any shopping lists outstanding that the store can fulfill, etc), along with customer loyalty reward status. Based on this information the customer 21 is then provided with a personalized shopping experience, including personal shopper, stylist and other recognition, along with discounts and services for which the customer may be eligible. In an embodiment, each store clerk is provided with a handheld device that is able to retrieve current store inventory matched against the individual customer preference, style suggestions, upcoming merchandise matching the consumer's preferences, etc.

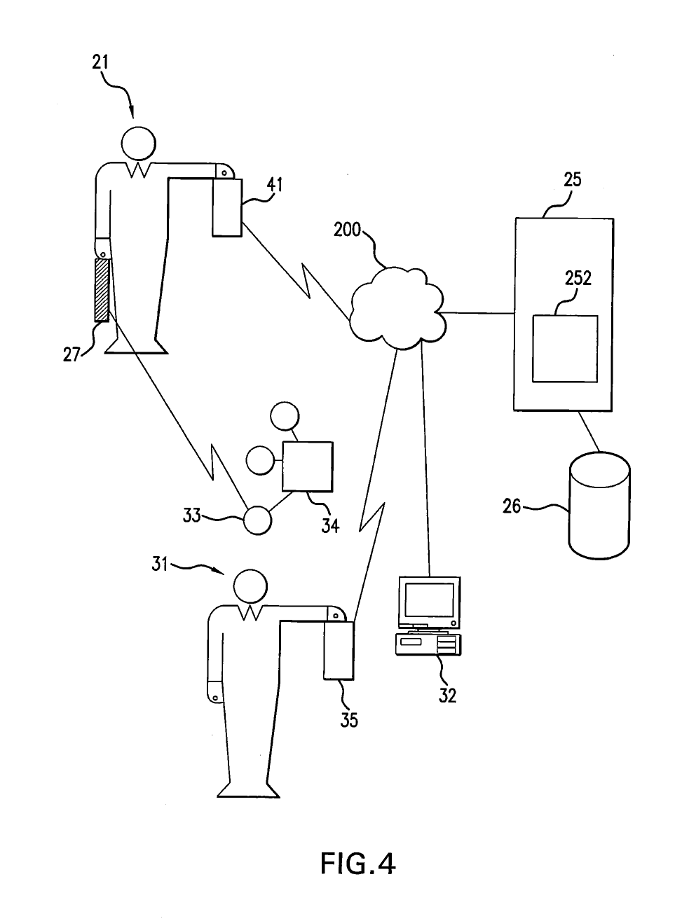

The above discussion relates to a situation where customer 21 previously indicated a preference for the store in her online profile. In a further embodiment, a system for offering an enhanced in-store experience to other customers (who have not indicated a preference for the store) is shown in FIG. 4. If customer 21 has a profile stored on database 26 but has not elected to share information with the store, portal 252 receives a detection signal as in the previous embodiment, and then automatically generates an e-mail, SMS or MMS message to the customer's mobile device 41, offering personalized service based on the applicable loyalty program. Alternatively, portal 252 may direct an alert signal to store personnel 31, giving the customer's contact information and prompting store personnel to send a personalized message to the customer.

Customer 21 may then respond to the message, either approving or declining the offer of customized shopping. The customer grants approval by sending a reply message to the store portal, authorizing sharing of her customer profile information with that store. In this situation, store personnel would only be permitted to access the customer's individual profile while the customer is inside the store.

The customer may make a shopping list in advance and transmit the list to the customer portal, thereby adding the shopping list to her profile. As part of the enhanced shopping experience, store personnel may retrieve the shopping list in addition to becoming familiar with the customer's preferences.

In an embodiment, the store portal may also receive billing data in order to update the customer's profile and the store loyalty system with relevant information.

### Customer Tracking; External Systems

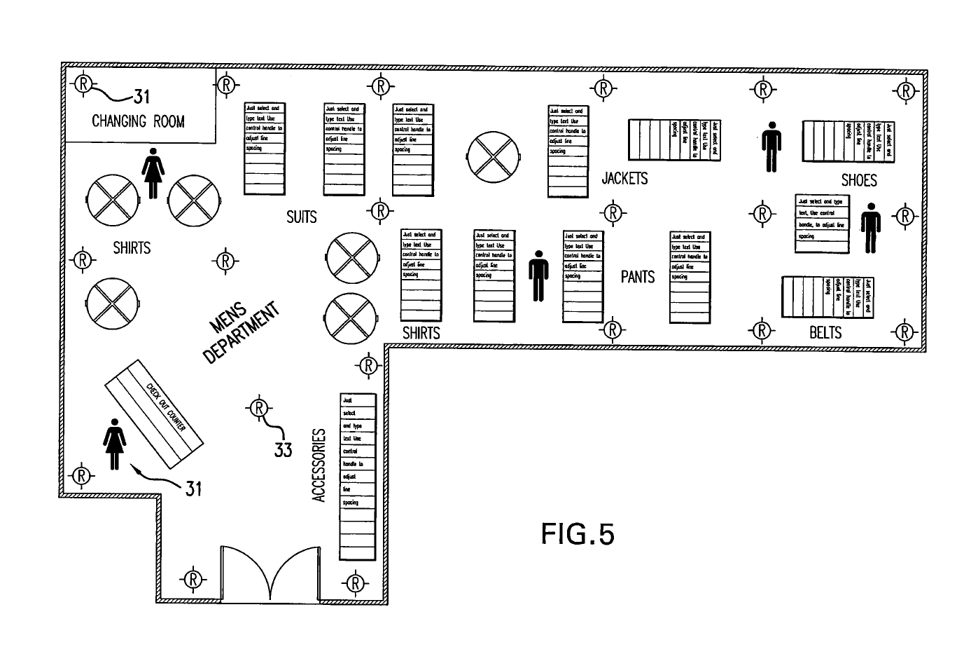

According to a further embodiment, an array of longer range RFID sensors 33 (having a range of about 3-5 m) is installed in the store to track the customer's movements through the store (see FIG. 5). As the customer visits different places in the store, thereby showing interest in specific items, store browsing data (that is, locations where the customer spent more than a few minutes) is collected and sent to the store portal 252, which then updates the customer's profile on database 26. The store browsing data is also compiled and added to intelligence data for the store.

More generally, all data relating to the customer's in-store experience (including but not limited to browsing and sales transactions) may be collected and stored in database 26. This data (also generally termed shopper intelligence data) permits retailers to better plan and respond to customer needs and preferences.

Retailers may integrate the CEM system described herein into their existing RFID based inventory control and supply chain systems in order to leverage the shopper intelligence information provided.

The CEM system may also include a custom module allowing integration with multiple loyalty programs that may be selected by the customer. In an embodiment, the module implements a table mapping the portal user ID to the various loyalty system identifications provided within the customer profile. Accordingly, all customer sales and transactional data collected may be transmitted to the relevant loyalty system via a custom designed procedure, allowing shoppers to receive the acquired customer loyalty points and benefits across programs without the need to carry additional loyalty reward membership cards.

### Automated Grocery Store CEM System

According to another embodiment of the disclosure, an automated grocery store CEM system provides grocery store preferred customers and loyalty members with a personalized customer shopping experience. Based upon RFID and other wireless technologies, this system delivers individualized product discounts, sales and other benefits based upon a customer's shopping preferences and membership loyalty rating, and at the same time provides automated redemption of manufacturers' discount coupons and a self-checkout service.

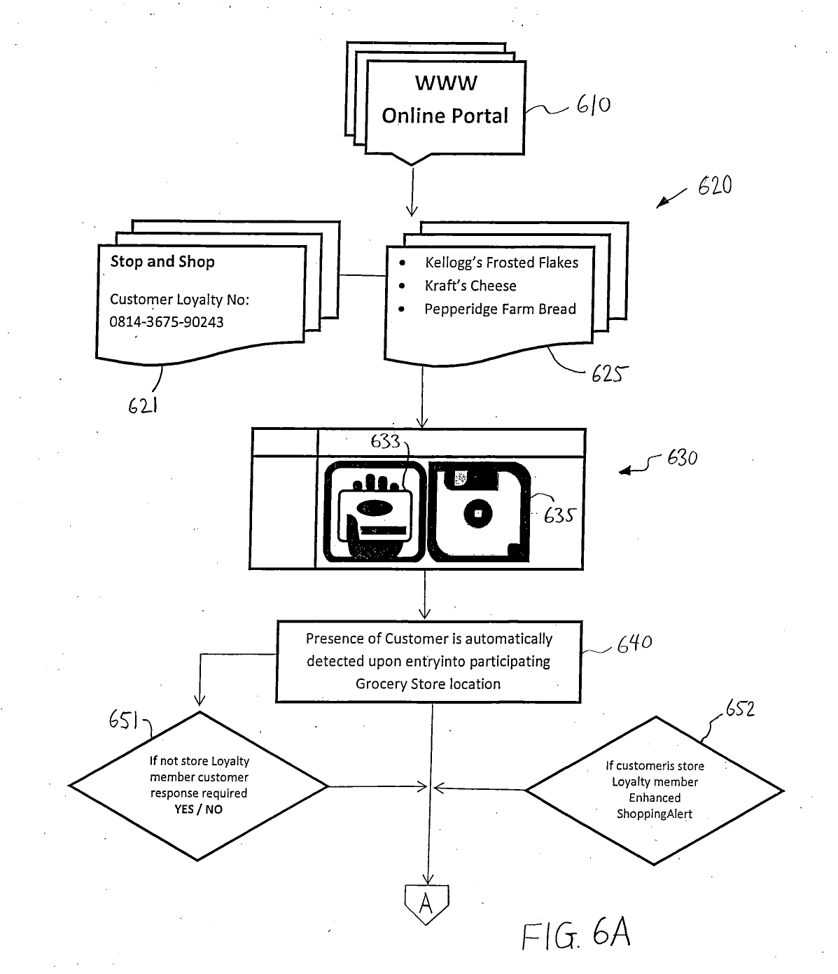

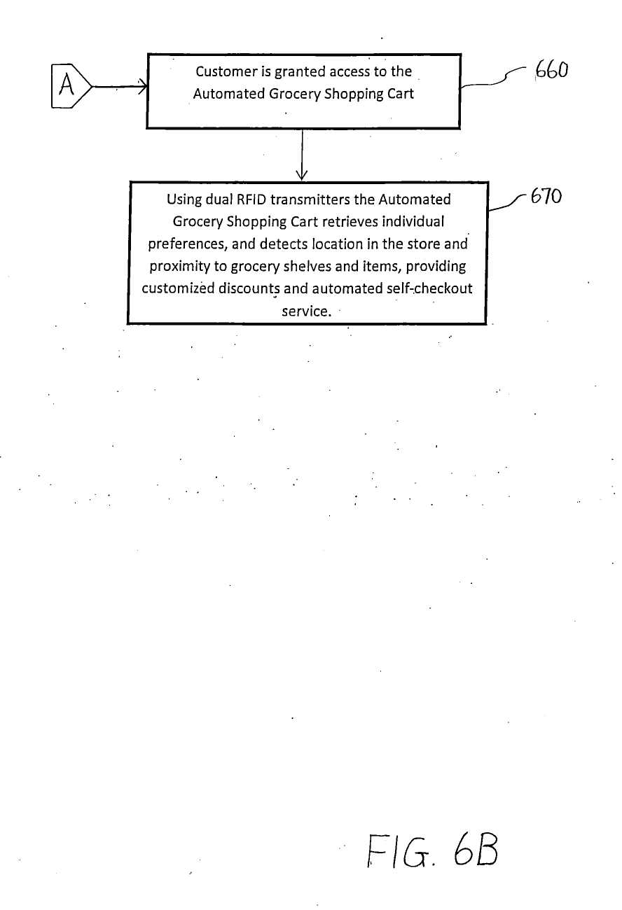

Steps in an automated grocery store CEM process, according to an embodiment, are shown in the flowchart of FIGS. 6A and 6B. In this embodiment, a customer may enjoy an enhanced shopping experience, provided by a CEM service, at any one of several stores. The customer initiates the process by registering for the service (step 610), indicating preferred grocery chains and providing details of existing customer loyalty program membership (step 621). Registering is advantageously done using an online portal such as the customer portal described above.

In step 620, the customer provides information 625 regarding brand preferences for various food and grocery items, e.g. Kellogg's Cereal, Kraft Cheese, Pepperidge Farm Bread, etc. In step 630, the customer is issued a unique, machine readable user identification token in the form of hardware or software 633, 635 embedded in a card, fob or other physical form factor combined with dual RFID wireless transmitters.

The presence of the customer bearing the unique user identification token is automatically detected via a wireless transmitter upon entry into a participating grocery store location (step 640). If the customer is determined (step 652) to be already a member of the grocery store customer loyalty program, s/he is automatically sent an automated text or alert message offering use of the enhanced shopping experience via the Automated Grocery Shopping cart, described in more detail below. If s/he is not a member of the store's loyalty program but that of a competing chain (step 651), then based upon the customer's indicated preferences an automated text or alert message is sent to the customer offering use of the enhanced shopping experience. A confirmation response from the customer will grant access to the Automated Grocery Shopping cart facility (step 660). The Automated Grocery Shopping cart uses RFID technology to automatically detect its location throughout the store aisles and relative to the customer's preferred items. In an embodiment, the Automated Grocery Shopping cart provides audiovisual alerts offering customized discounts to the customer when in the vicinity of shelves holding customer preferred items and brands, items on the customers shopping list or those for which the customer has a valid manufactures discount coupon. Additionally individualized discounts and other preferred customer benefits may be offered automatically based upon the customer's past shopping history, customer loyalty status and other eligibility ratings that may be determined by the store. The Automated Grocery Shopping cart also provides an automated self-checkout service to the customer (step 670).

### Automated Grocery Shopping Cart

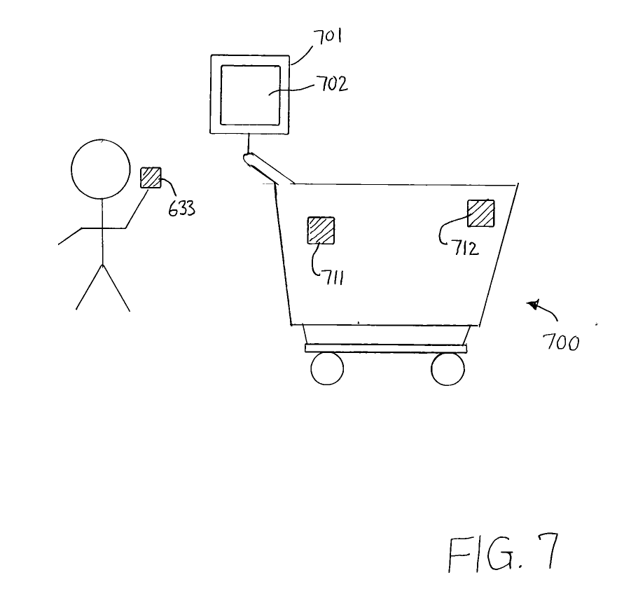

The Automated Grocery Shopping Cart, schematically shown in FIG. 7, is an enhanced shopping cart 700 that is equipped with an integrated Audio Visual Display unit 701 capable of accepting touch, textual and verbal inputs (including touch input via screen 702) and displaying audiovisual discount information and benefits relevant to the customer proximate to the cart. The cart is equipped with two RFID transmitters 711, 712. In this embodiment, transmitter 711 has a range of about 1.5 m to detect the proximity of the customer's user identification token 633, while transmitter 712 has a range of about 3-5 m for sensing the cart's physical location within the grocery store premises.

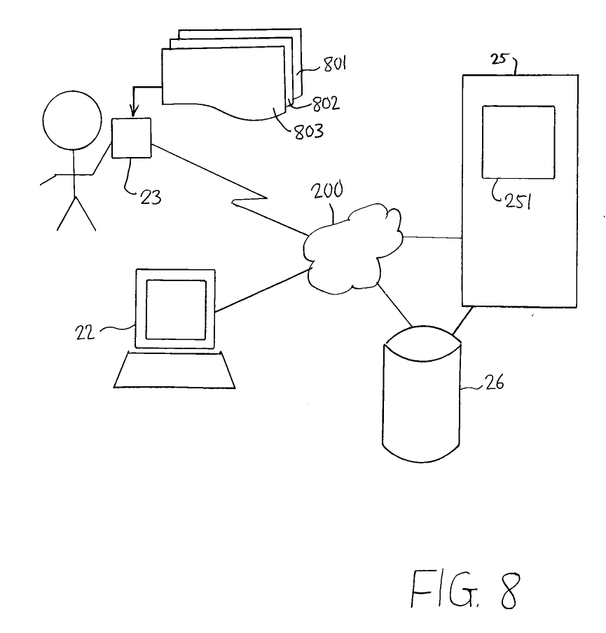

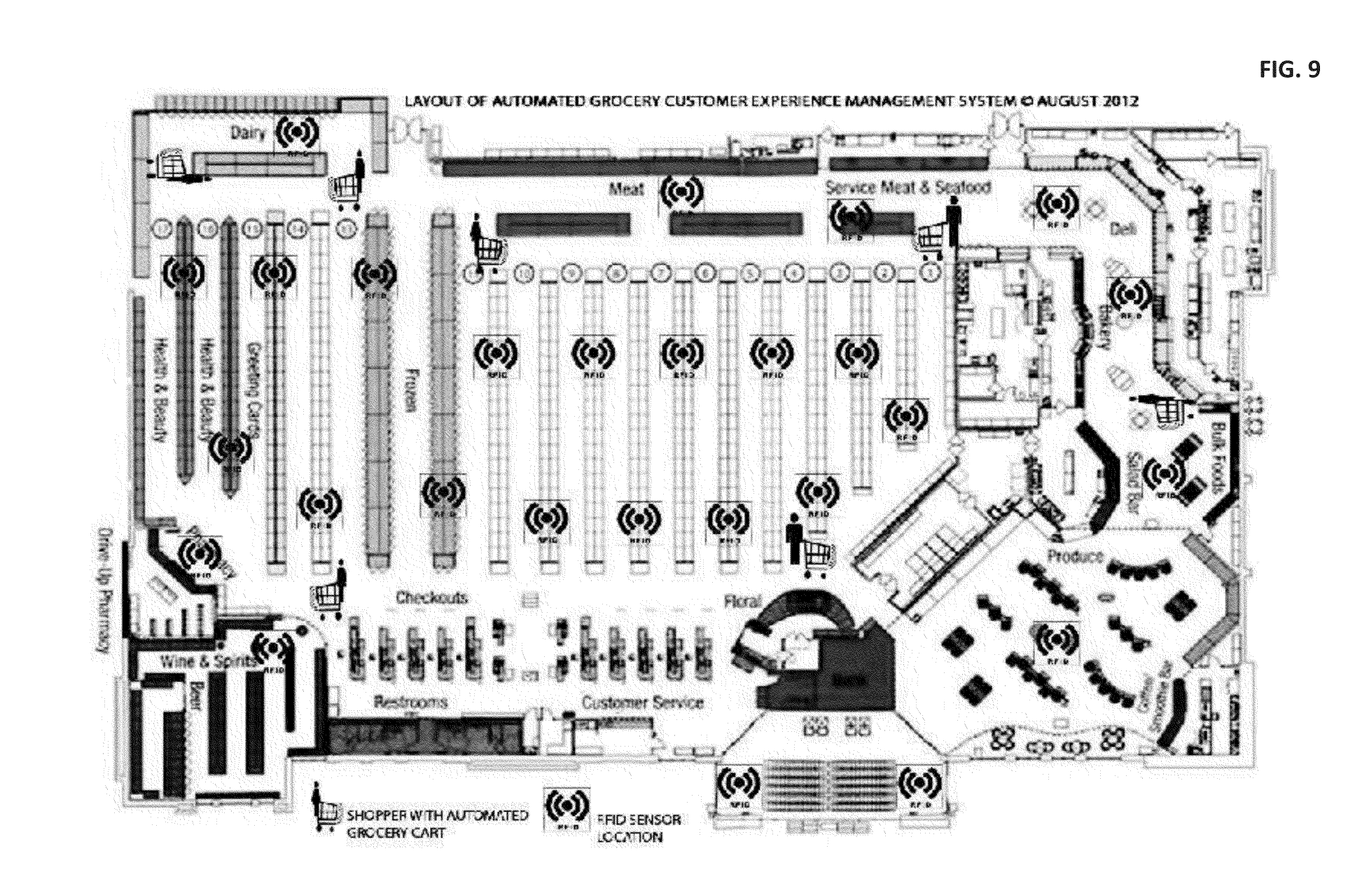

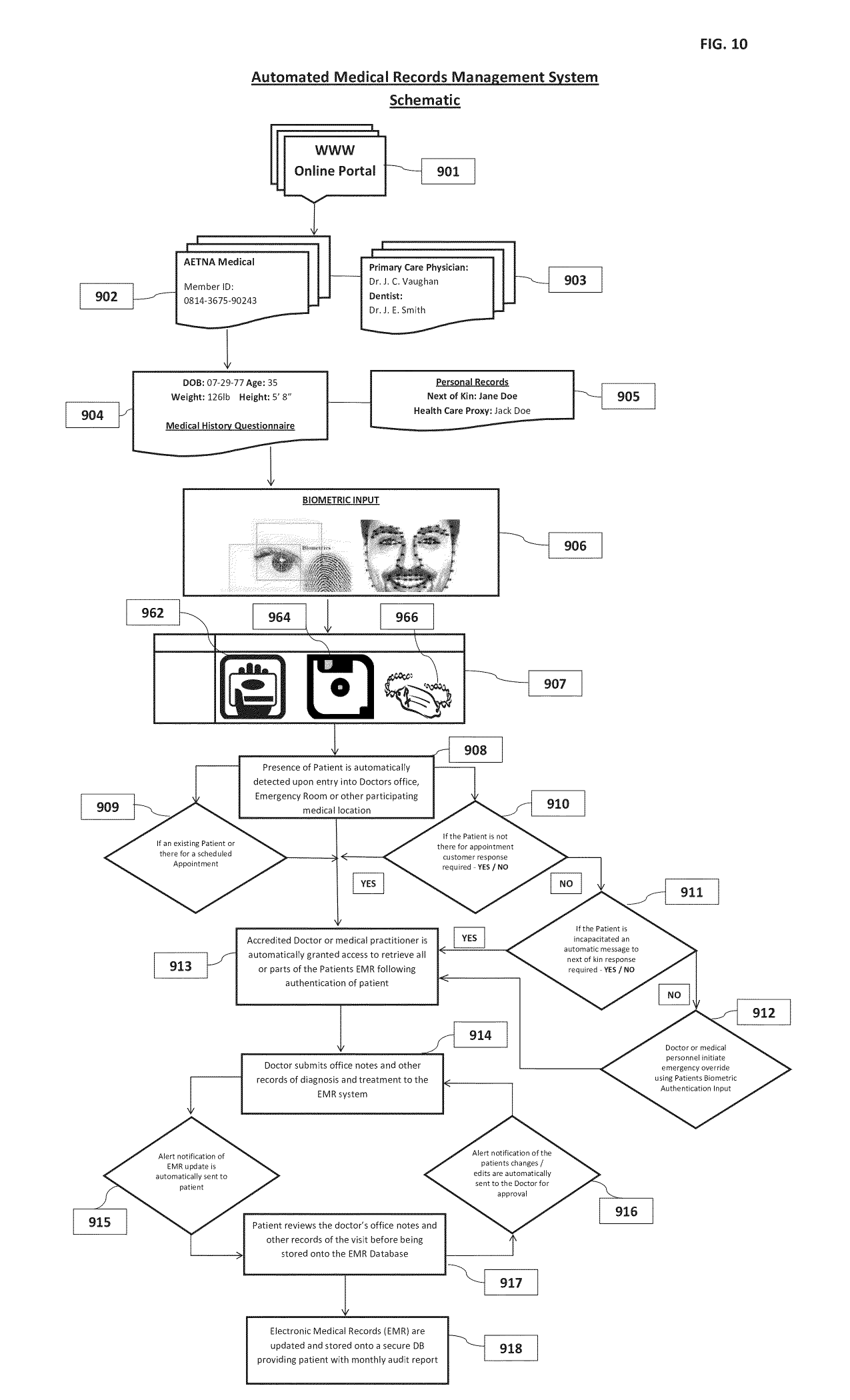

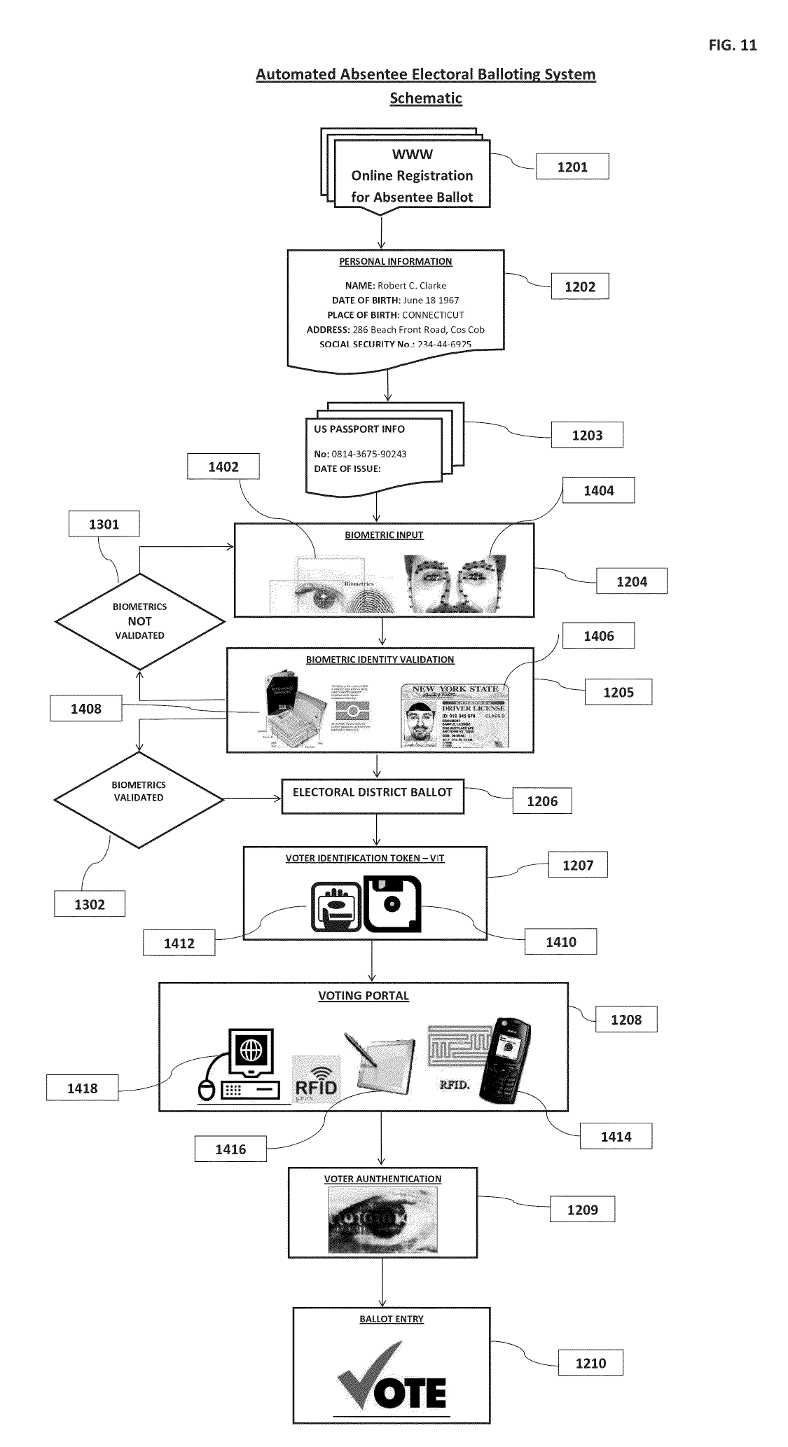

The Automated Grocery Shopping cart identifies the customer based upon the user identification token, and retrieves information specific to that customer from the CEM system database 26. As shown schematically in FIG. 8, the customer may store information in his/her user profile on database 26 via online portal 251, accessing portal 251 through network 200 by any of a variety of devices, including a home computer 22 or a mobile device 23. Information provided by the customer may include shopping lists 801, recipes 802, manufacturers' discount coupons 803, loyalty discount information and other individual preferences. In this embodiment, the customer may scan, photograph, or enter UPC barcode information for coupons 803; this information is saved onto the customer's individual user profile.

As the customer walks through the aisles of the grocery store, the audiovisual unit 701 on the Automated Grocery Shopping cart 700 displays sales, discounts, and promotional information that is contextual and relevant to the items located on the nearby shelves and customized to the individual customer. Shopping cart 700 may also include a barcode scanner (advantageously integrated into unit 701) to scan the SKU/UPC barcode for items as they are placed in the cart. Items placed into the cart are thus automatically detected; relevant pricing and tax information is calculated and displayed on screen 702, thereby providing automated checkout capability.

While the disclosure has been described in terms of specific embodiments, it is evident in view of the foregoing description that numerous alternatives, modifications and variations will be apparent to those skilled in the art. Accordingly, the disclosure is intended to encompass all such alternatives, modifications and variations which fall within the scope and spirit of the disclosure and the following claims.

Claim I:

1. A method for engaging a customer in an enhanced shopping experience, comprising:
storing customer information received from the customer on a database;
issuing an identifying token to the customer;
detecting the identifying token when carried by the customer into a retailer's space;
activating an automated shopping cart to retrieve the customer information from the database using a computing device included in said shopping cart, in accordance with
a determination that the customer belongs to a loyalty program of the retailer, or
a confirmation message transmitted by the customer in response to an offering message sent by the retailer to the customer;
detecting proximity of the customer to said shopping cart using a first RFID transmitter included in said shopping cart;
detecting a location of said shopping cart within the retailer's space using a second RFID transmitter included in said shopping cart, the second RFID transmitter having a longer range than the first RFID transmitter; and
displaying customized information regarding an item proximate to the shopping cart, using a display device operatively connected to said computing device,
the customized information including information regarding the item and relevant to the retrieved customer information, the retrieved customer information being at least one of a shopping list, a recipe, information from a discount coupon, and an historical or indicated preference of items and brands purchased by the customer

2. A method according to claim 1, further comprising:
scanning a code associated with the item using a scanning device included in said shopping cart, thereby obtaining price information for the item;
calculating a total price for items in said shopping cart, including applicable tax; and
displaying the total price using the display device.
prompt for acceptance and authorization of payment for total amount of items contained within the shopping cart using associated credit card, debit card, checking account or other forms of (electronic) payment
